(19) United States
(12) Patent Application Publication
(10) Pub. No.: US 2011/0009053 A1
(43) Pub. Date: Jan. 13, 2011

(54) Tactical radio relay system

(76) Inventors: Richard L. Anglin, JR., Del Mar, CA (US); Bradley T. Tipler, San Diego, CA (US)

Correspondence Address: Thomas N. Giaccherini, Post Office Box 1146, Carmel Valley, CA, 93924, US

(21) Appl. No.: 12/459,858

(22) Filed: Jul. 7, 2009

(51) Int. Cl. H04B 17/02; H04B 7/15

(52) U.S. Cl. 455/9; 455/11.1

(57) ABSTRACT

Methods and apparatus for providing a Tactical Radio Relay System. One embodiment of the invention includes a constellation of miniature radio relays. These relays may be deployed on buildings or structures to provide a temporary telecommunications system that is capable of communicating with a base station or with mobile terminals. In an alternative embodiment, the relays include parachutes made from thin film batteries, and may be dropped over a target communications zone from an airborne platform.

### FIELD OF THE INVENTION

One embodiment of the present invention pertains to methods and apparatus for providing a temporary radio relay network, using miniature transceivers. More particularly, one embodiment of the invention comprises a system for providing a telecommunications system for the military, police or other security forces.

### FEDERALLY SPONSORED RESEARCH OR DEVELOPMENT

None.

### BACKGROUND OF THE INVENTION

Conventional military, police and security communication systems typically include a base station and mobile terminals. In some cases, terrestrial repeaters or satellites may be utilized. In some settings, ground structures or battlefield conditions may limit the performance of these conventional systems.

The development of a versatile system that is capable of supplying a wide range of telecommunications capabilities in a battlefield or security environment would constitute a major technological advance, and would satisfy long felt needs and aspirations of the telecommunications industry.

### SUMMARY OF THE INVENTION

One embodiment of the present invention comprises a Tactical Radio Relay System. One embodiment of the invention comprises a constellation of miniature radio relay transceivers, which are deployed in a target communications zone. These miniature transceivers may communicate with one or more of the constellation, and generally serve as relays between a base station and a mobile terminal, or between two or more mobile terminals.

An appreciation of the other aims and objectives of the present invention and a more complete and comprehensive understanding of this invention may be obtained by studying the following description of a preferred embodiment, and by referring to the accompanying drawings.

### A BRIEF DESCRIPTION OF THE DRAWINGS

FIG. 1 shows a preferred embodiment of the Tactical Radio Relay System.

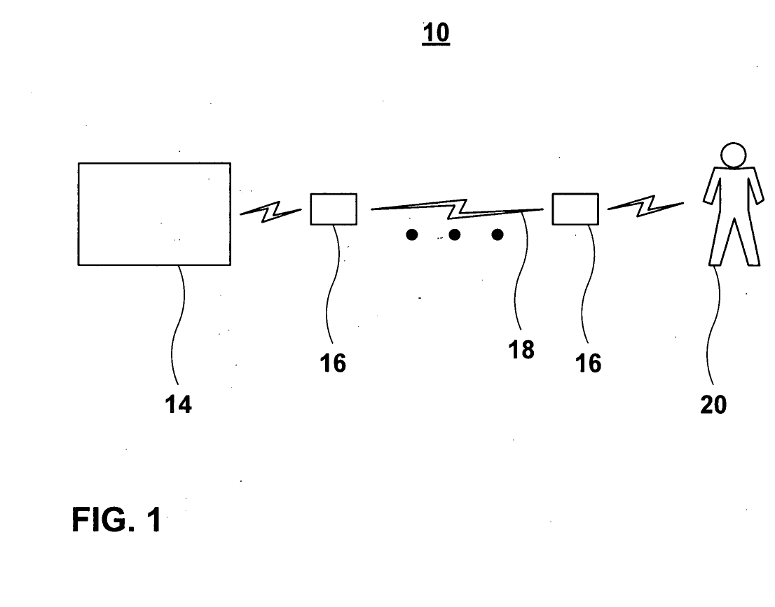

FIG. 2 shows a preferred embodiment of the Tactical Radio Relay System using an Unmanned Ground Vehicle.

FIG. 3 shows a preferred embodiment of the Tactical Radio Relay System using an Unmanned Aerial Vehicle.

FIG. 4 shows a preferred embodiment of the Tactical Radio Relay System using an Unmanned Surface Vehicle.

FIG. 5 shows a preferred embodiment of the Tactical Radio Relay System using an Unmanned Underwater Vehicle.

FIG. 6 shows a preferred embodiment of a deployable radio communications node.

FIG. 7 shows a preferred embodiment of a deployable radio communications node with a mesh antenna.

FIG. 8 shows two alternative embodiments of the body of a deployable radio communications node.

FIG. 9 shows an alternative embodiment of a deployable radio communications node with antennas mounted on the exterior of the sphere.

FIG. 10 shows two embodiments of a deployable radio communications node for use in a maritime environment.

FIG. 11 shows two embodiments of techniques to hold maritime embodiments of deployable radio communications node in positions relatively fixed in relation to the points at which they are deployed.

FIG. 12 shows alternative embodiments of airborne deployable remote communications nodes.

FIG. 13 shows an embodiment of a deployable radio communications node that includes one or more sensors.

FIG. 14 shows two alternative embodiments of space frame embodiments of a deployable radio communications node.

FIG. 15 shows embodiments of adhesion systems.

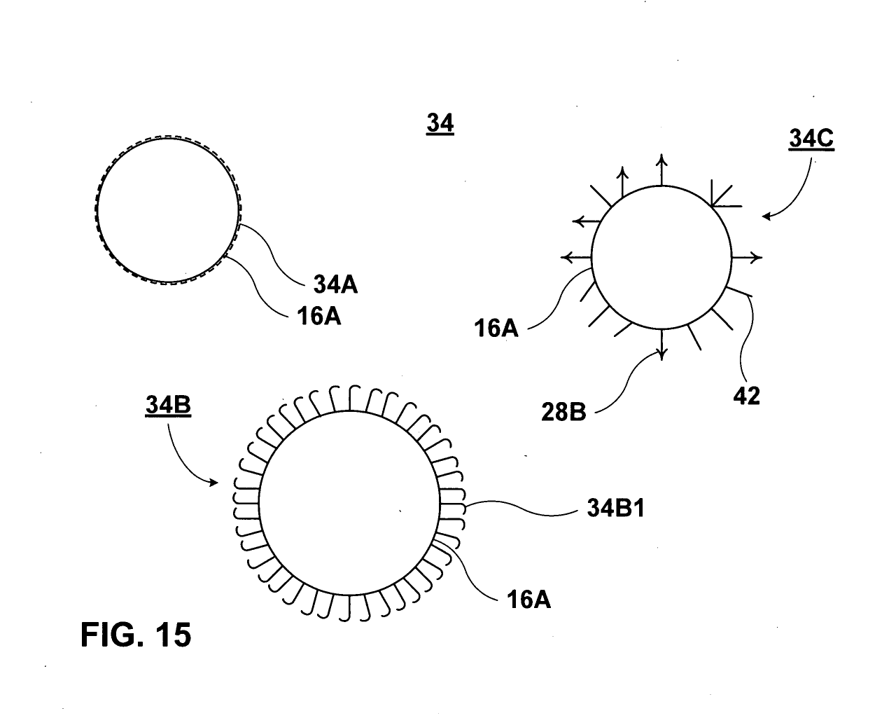

FIG. 16 shows an embodiment of a canister for spherical deployable radio communications nodes.

FIG. 17 shows an embodiment of a canister for maritime deployable radio communications nodes.

FIG. 18 shows pneumatic and pyrotechnic embodiments of deployment systems.

FIG. 19 shows a ballistic embodiment of a deployment systems.

FIG. 20 shows deployment of a deployable radio communications node triggered by a threshold signal-to-noise ratio.

FIG. 21 shows manual deployment of a deployable radio communications node using a camera mounted on the canister to identify a desirable location.

FIG. 22 shows preferred embodiments of deployable radio communications node activation means.

FIG. 23 shows an alternative deployment embodiment in which multiple Unmanned Ground Vehicle communicate via parachute-born radio relay nodes.

FIG. 24 shows an alternative pyrotechnic deployment embodiment in which snowflake-based radio relay nodes are used to communicate between an Unmanned Ground Vehicle and a controller.

FIG. 25 shows hand emplacement of a deployable radio communications node with a camera.

### A DETAILED DESCRIPTION OF PREFERRED & ALTERNATIVE EMBODIMENTS

### I. Overview of the Invention

The present invention comprises a temporary telecommunications for use on the battlefield, or in an environment which must be controlled by security forces, such as the site of a bomb blast or the aftermath of a hurricane. In one embodiment, miniature radios, sensors, transceivers or radio means are deployed on objects, buildings or structures, and form a constellation, cloud or plurality of relays, furnishing a wireless network between a base station and a mobile terminal; an aircraft; a ground or water vehicle; a satellite; or between or among a number of mobile terminals.

### II. Preferred & Alternative Embodiments

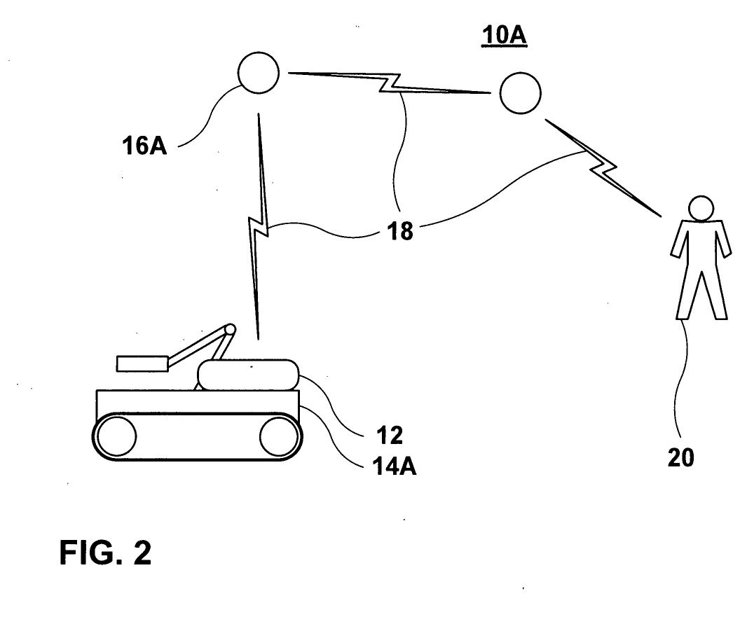

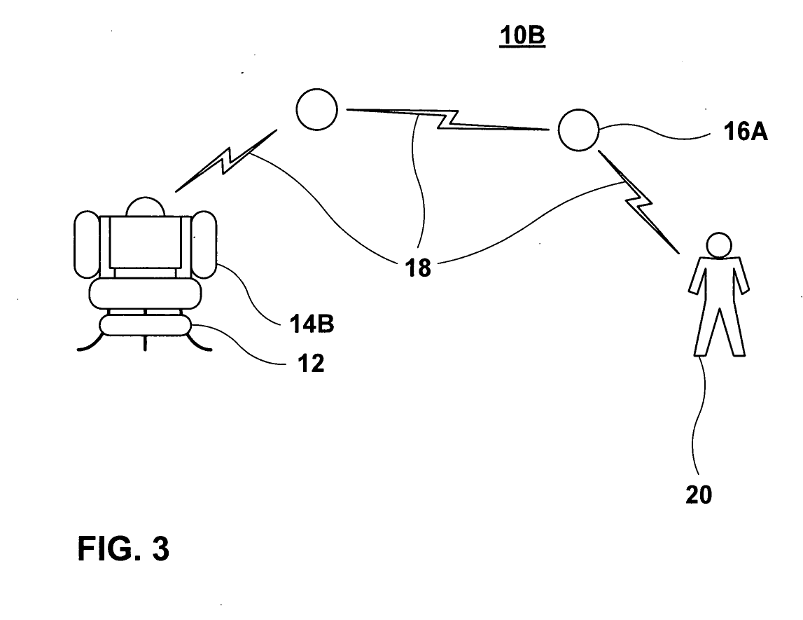

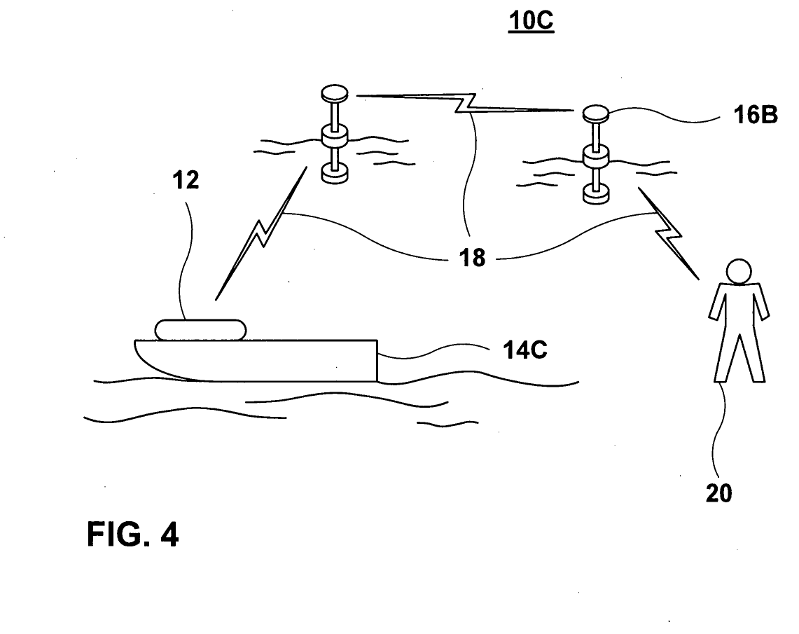

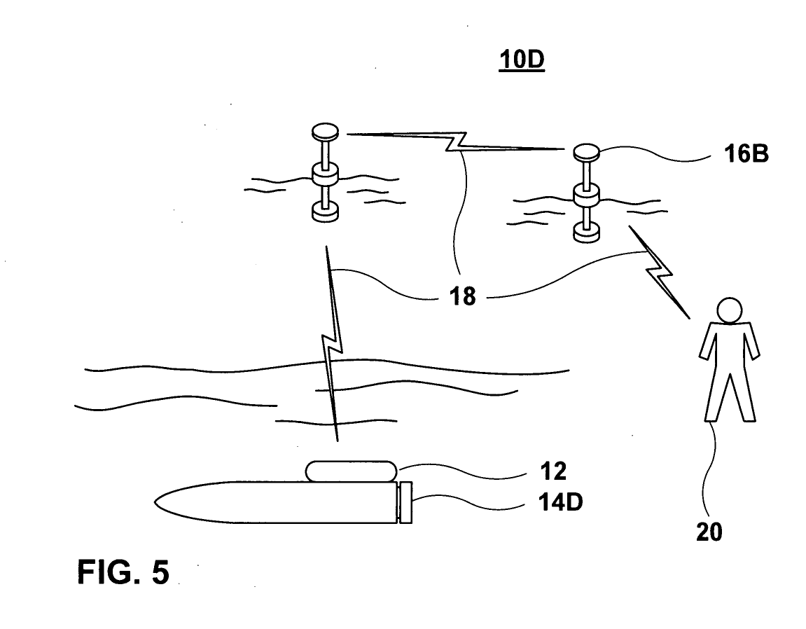

One embodiment of the Tactical Radio Relay System 10 comprises one or more containers or canisters 12 affixed to an Unmanned Ground Vehicle (UGV) 14A or an Unmanned Aerial Vehicle (UAV) 14B or an Unmanned Surface Vehicle (USV) 14C or an Unmanned Underwater Vehicle (UUV) 14D, collectively called “UxVs” 14. These canisters 12 contain miniature radio communications relays, radios or nodes 16 that are deployed or dispensed to provide communications 18 between an UxV 14 and the system's controller 20. FIG. 2 shows a preferred embodiment of the Tactical Radio Relay System 10A based upon an UGV 14A, and FIG. 3 an embodiment of the Tactical Radio Relay System 10B based upon an UAV 14B. FIG. 4 shows an embodiment of the Tactical Radio Relay System 10C based upon an USV 14C, and FIG. 5 an embodiment of the Tactical Radio Relay System 10D based upon an UUV 14D.

In this Specification and in the Claims that follow, the term “radio” encompasses any device comprising software and/or hardware that may be used to wirelessly transmit and/or receive signals, data, voice, video, code or any other form of cognizable pattern or intelligence. The term “deployable” is intended to connote any device or system which may be affixed, coupled, connected, positioned, assigned, stationed, distributed, dispensed, shot, propelled, guided, sprayed, spread, set out, readied, arranged, or otherwise furnished or made available for use.

The invention is intended to provide a temporary communications system. The term “temporary” connotes a limited amount of time. This limited amount of time may be delineated by the length of life of the power supply of each radio, or may be defined by the time required until specific mission objectives have been achieved.

### III. Communications Nodes

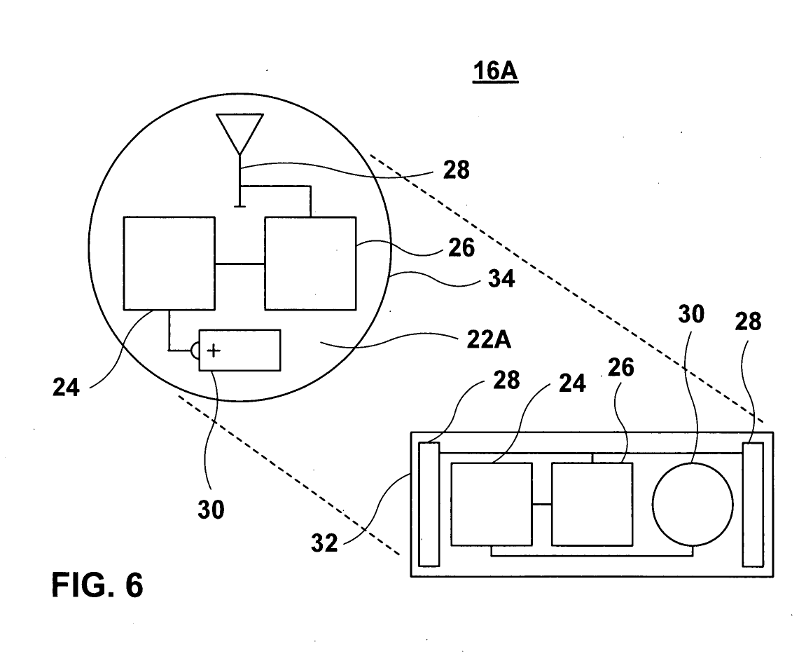

FIG. 6 shows a preferred embodiment of a deployable miniature radio communications relay, radio or node 16A. The overall shape of the embodiment shown in FIG. 6 is a sphere; alternative embodiments may be configured in any ovoid shape. The body 22A of this embodiment of a deployable radio communications node 16 is foam. In this Specification and in the Claims that follow, the term “foam” refers to any substance which, when formed, traps gas bubbles in a liquid or a solid. The foam 22A in the instant embodiment is closed cell foam; alternative embodiments may use open cell foam. The invention may be implemented using any suitable geometric configuration or means of protection for the radio.

The invention may be implemented using cellular, UHF, VHF, Wi-Fi, WiMAX, MIMO, ISM or any other suitable frequency bands.

Embedded into the body 22A of the deployable radio communications node 16A are a system function controller 24, a wireless radio system 26, one or more antennas 28 for the wireless radio system 26, and a battery 30. In a preferred embodiment the system controller 24, wireless radio system 26, antennas 28 and battery 30 may be mounted on a single circuit board 32. In an alternative embodiment, the radio may be powered by a photovoltaic cell.

The exterior of the body 22A is covered by an adhesion means or system 34 to enable the deployable radio communications node 16A to be adhered or affixed to a surface.

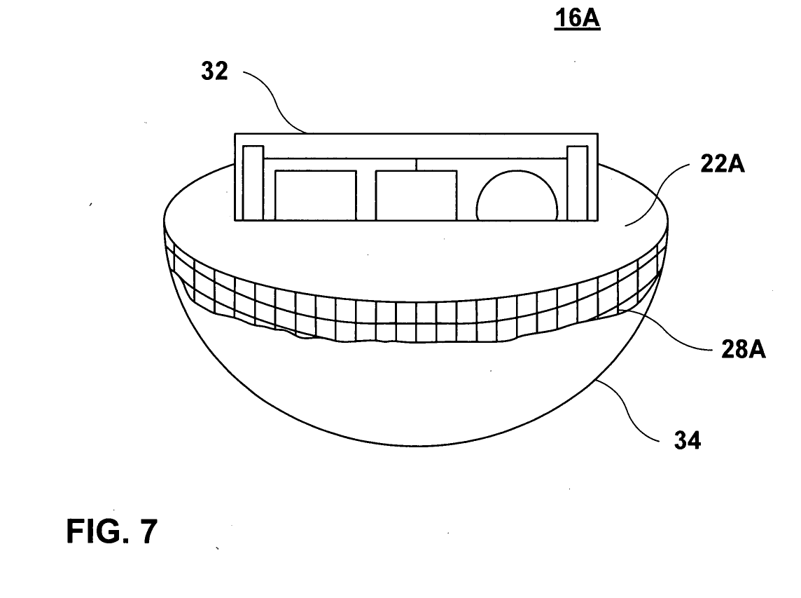

In an alternative embodiment the antenna 28 may be a radio frequency conductive mesh 28A affixed to the exterior of the body 22A underneath the adhesion system 34, as shown in FIG. 7.

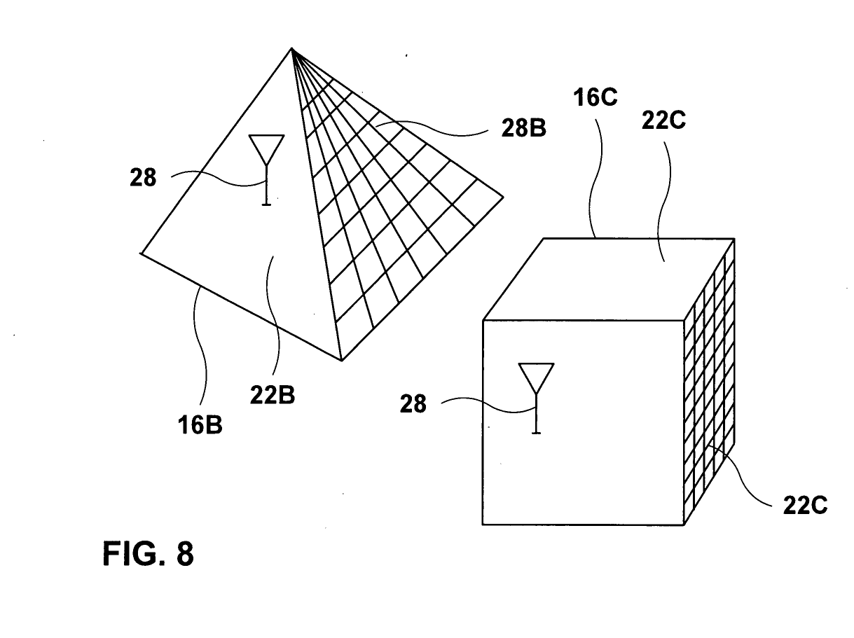

An alternative form of the body 22 of a deployable radio communications node 16 is a multifaceted solid. Two alternative embodiments are shown in FIG. 8, a tetrahedron 16B and a cube 16C. As the number of facets on the body increases, the body 22 can approximate a sphere or other ovoid shape. As described above for a sphere, the antennas 28 may either be embedded into the body 22B of the tetrahedron 16B or the cube 16C, or as mesh 28B, 28C affixed to the surface of the tetrahedron 16B or cube 16C underneath the adhesion system 34.

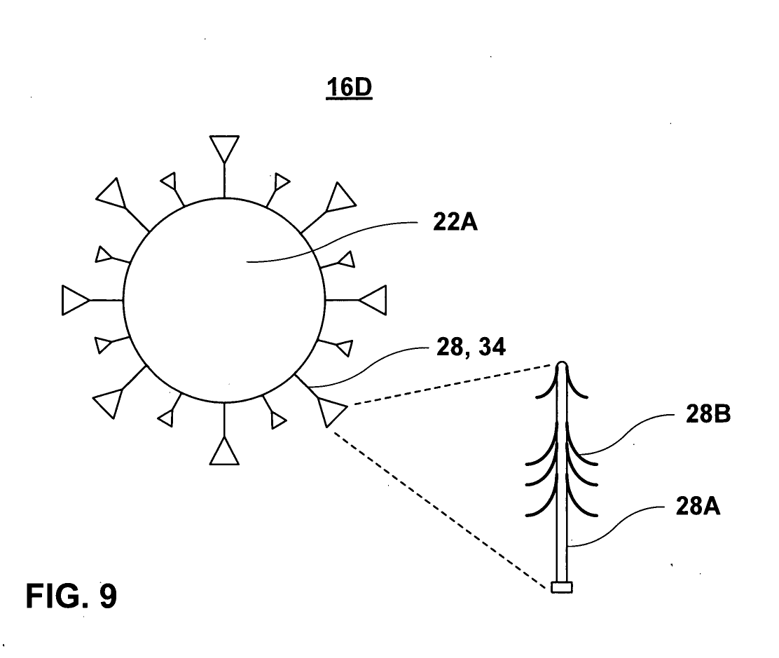

An alternative embodiment of a deployable radio communications node 16D is shown in FIG. 9. In this embodiment the antennas 28 are mounted on the exterior of the node 16D and comprise an element of the adhesion system 34. In a preferred embodiment the antenna shafts 28A are made of flexible materials with barbs 28B or other features on the ends or along the shaft that enable the deployable radio communications node 16D to adhere to a surface.

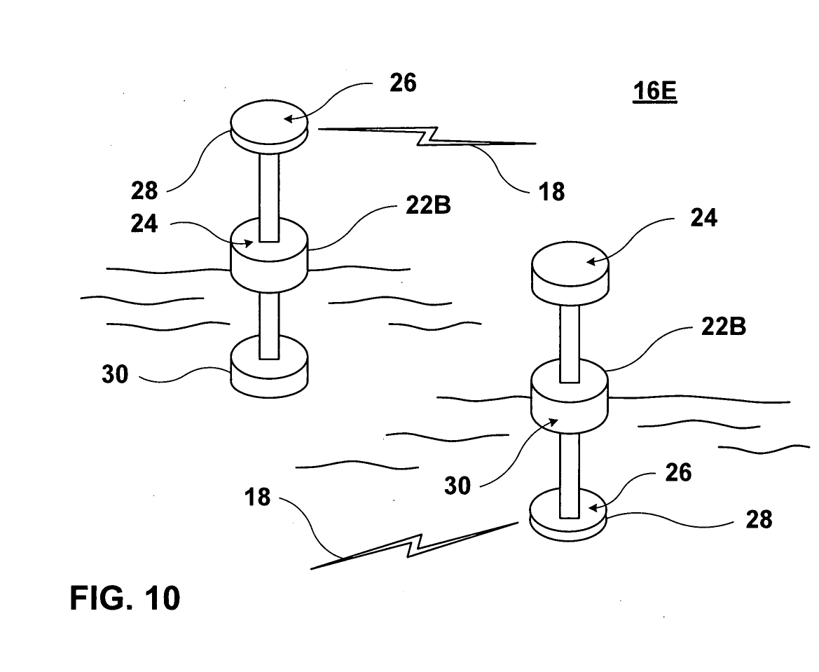

FIG. 10 shows two embodiments of a deployable radio communications node 16E for use in a maritime environment, one for communications above the surface of the water and one for underwater communications. The embodiments shown in FIG. 10 are designed to float. A preferred embodiment uses a foam body 22B. In the embodiment for communications above the surface of the water, the battery 30 is underwater and acts as a counterweight to the foam body 22B. The antenna(s) 28 ride above the surface of the water. In the embodiment for communications below the surface of the water, the battery 30 is part of the body 22B and the antenna(s) 28 are deployed below the surface of the water.

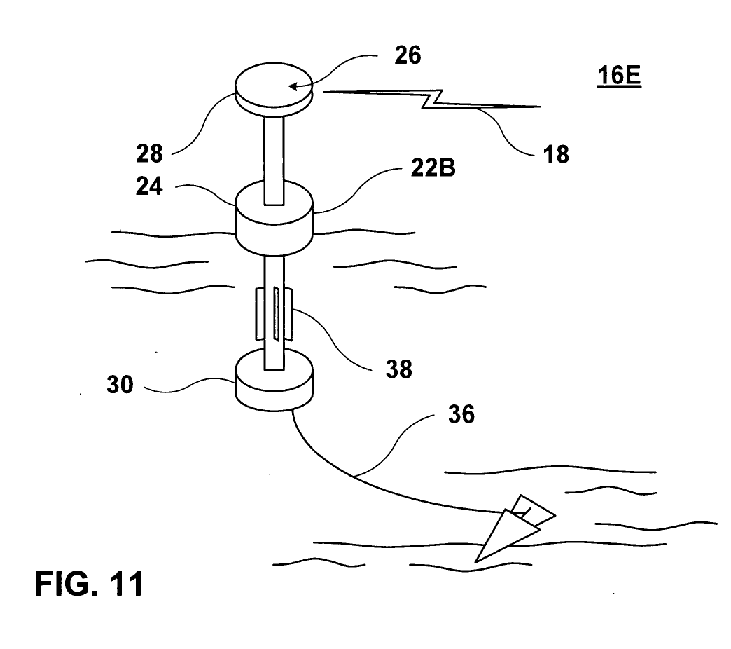

In some situations maritime deployable radio communications nodes 16E may be deployed and allowed to drift with currents. In other situations they need to be relatively fixed in relation to the positions in which they are deployed. There are a variety of techniques available to keep maritime deployable radio communications nodes 16E in relatively fixed locations, as shown in FIG. 11. One technique is an anchor system 36, another is a rotary vane system 38.

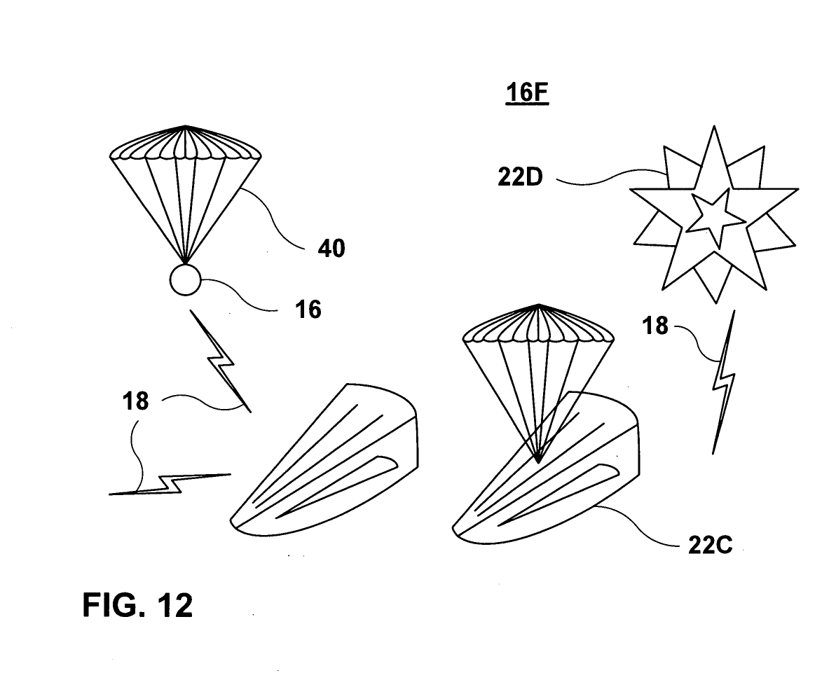

FIG. 12 shows alternative embodiments of airborne deployable remote communications nodes 16F. One embodiment adds a parachute 40 to a deployable radio communications node 16. In a second embodiment the body 22C of the deployable radio communications node is a lifting body, without or with a parachute 40 added. A third embodiment of the body 22D of an airborne deployable radio communications node is a snowflake shape.

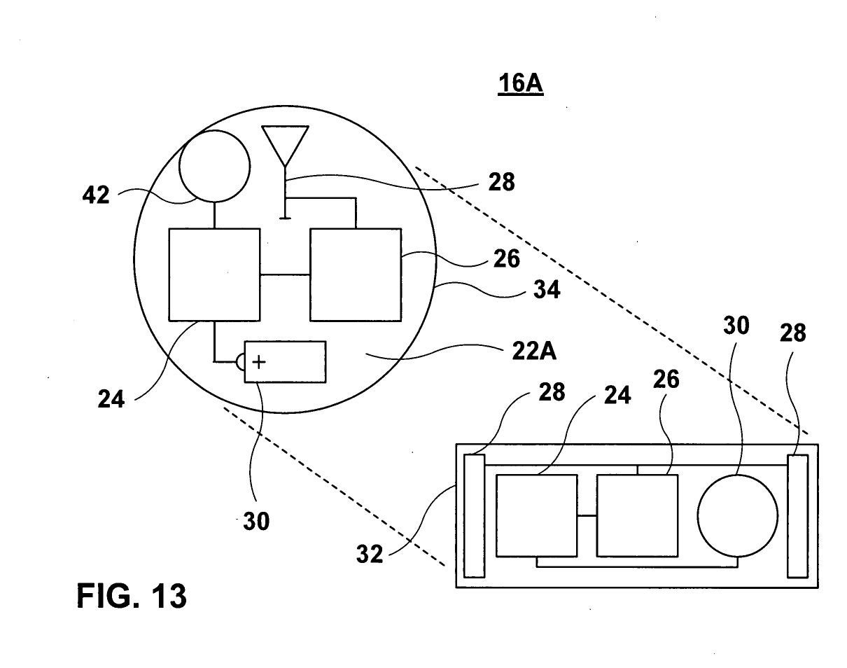

Any of the embodiments of a deployable radio communications node may include one or more sensors 42, as shown in FIG. 13. Sensors 42 may include but are not limited to electro-optical (EO), infrared (IR), ultraviolet (UV), radar, acoustic, mechanical, and audio.

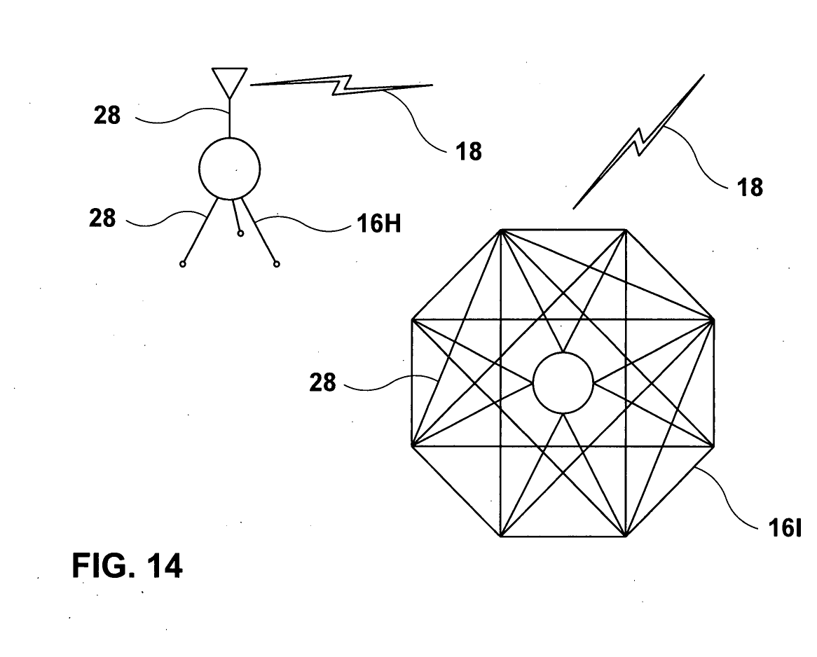

An alternative form of the body 22 of a deployable radio communications node 16 is a multifaceted space frame. Two alternative embodiments are shown in FIG. 14, a tripod 16B and an octagon 16C. As the number of elements of a space frame increases, the deployable radio communications node can approximate a sphere or other ovoid shape. In the embodiments shown in FIG. 14 the antennas 28 are the elements of the space frame.

### IV. Canisters

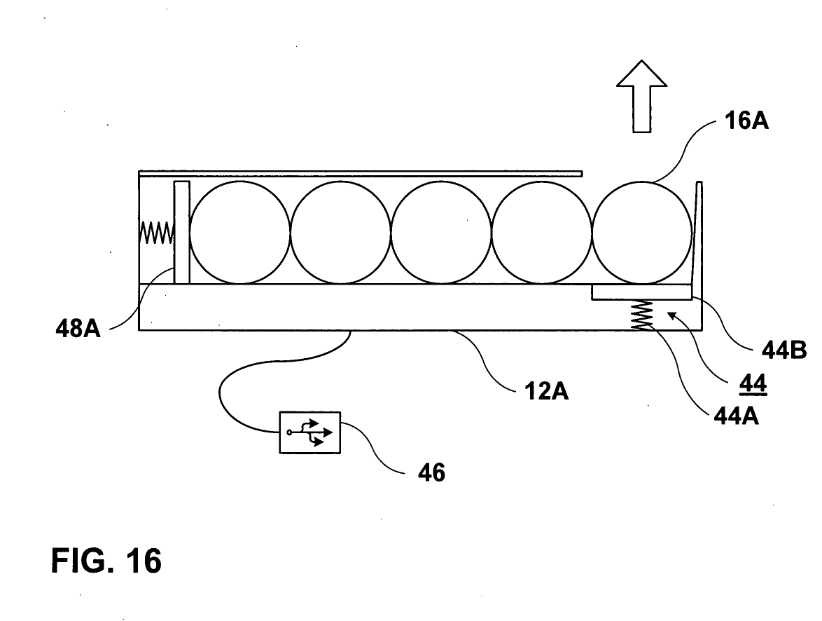

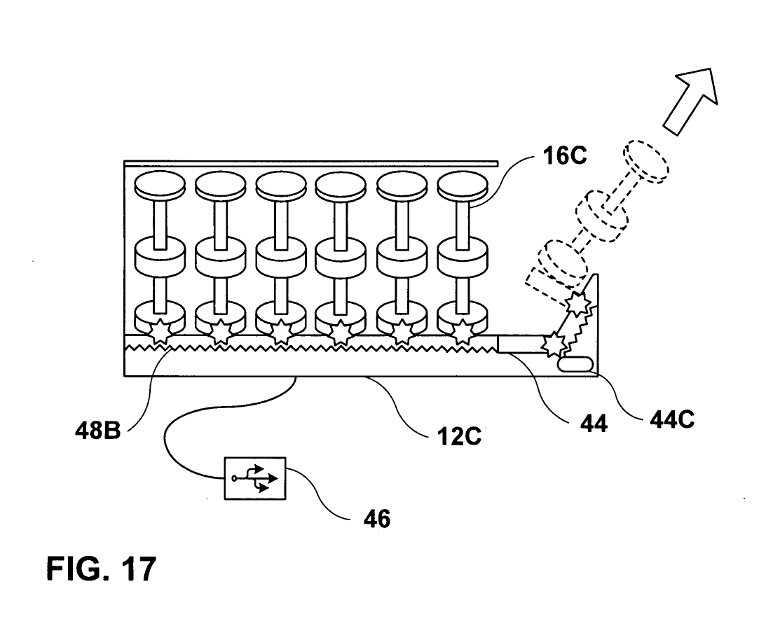

The canister 12 of the Tactical Radio Relay System 10 serves multiple functions. The invention may be implemented using any suitable form of container, envelope, vessel, compartment or other means to store or hold the radios. In one embodiment, the canister 12 stores the deployable radio communications nodes 16 prior to deployment, it includes a deployment system 44 the deployable radio communications nodes 16, and it provides the control interface between the UxV 14 and the Tactical Radio Relay System 10. FIG. 16 shows an embodiment of a canister 12A for spherical deployable radio communications nodes 16A, and FIG. 17 shows an embodiment for maritime deployable radio communications nodes 16C, 16D.

The canister 12 may store a plurality of deployable radio communications nodes 16 and include a mechanism 48 for moving them from their stored position into the deployment system 44. The mechanism 48A embodiment shown in FIG. 16 is a plunger and spring that moves the deployable miniature radio communications, relays or nodes 16A into the deployment system 44. The mechanism 48B embodiment shown in FIG. 17 is a cog and tooth system that may be powered mechanically, electrically, pneumatically or otherwise.

Deployment systems 44 may be mechanical, electrical, pneumatic, pyrotechnic, ballistic or otherwise. The deployment system 44 shown in FIG. 16 displays a mechanical system, a spring 44A that causes the ejection plate 44B to eject the deployable radio communications node 16A. In FIG. 17 the deployment system 44 is powered by an electric motor 44C.

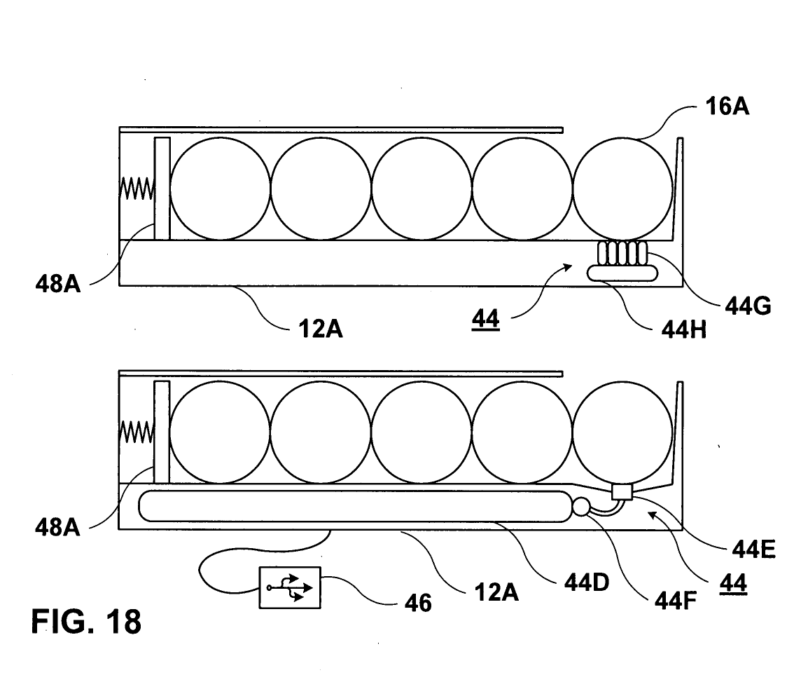

FIG. 18 shows both pneumatic and pyrotechnic deployment systems 44. In the pneumatic embodiment, compressed gas is stored in a tank 44D that is released through a nozzle 44E controlled by a valve 44F to eject a deployable radio communications node 16A. In the pyrotechnic embodiment pyrotechnic means 44G are fired by a controller 44H to eject a deployable radio communications node 16A.

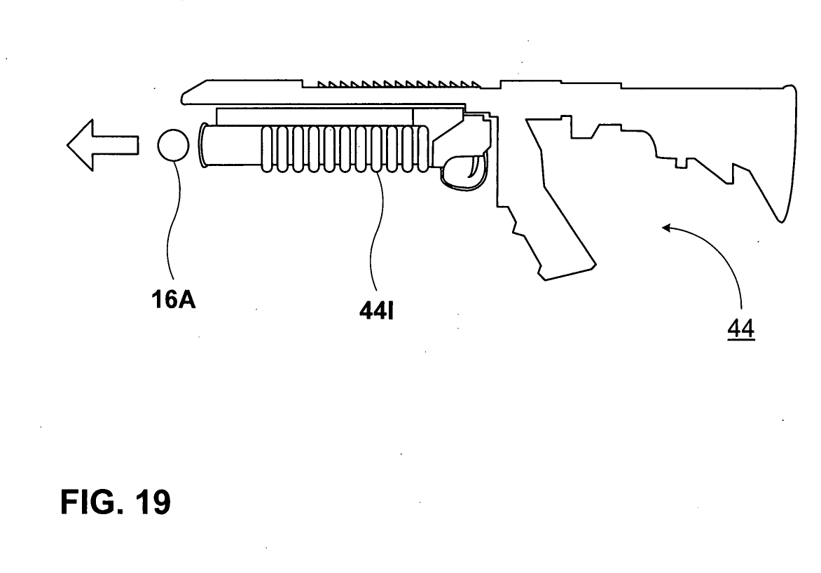

FIG. 19 shows a ballistic deployment system 44 using an M203PI 40 mm Enhanced Grenade Launcher Modular (EGLM) System 441.

### V. Placement

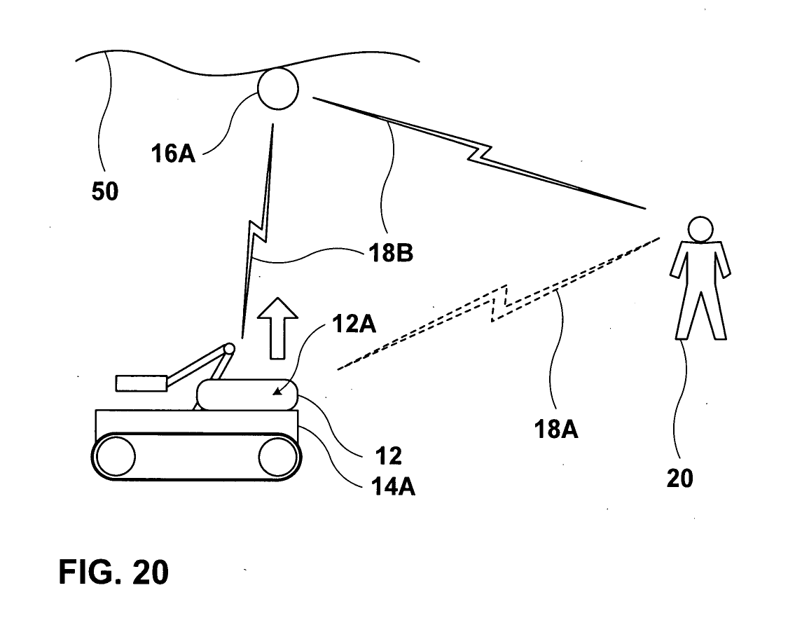

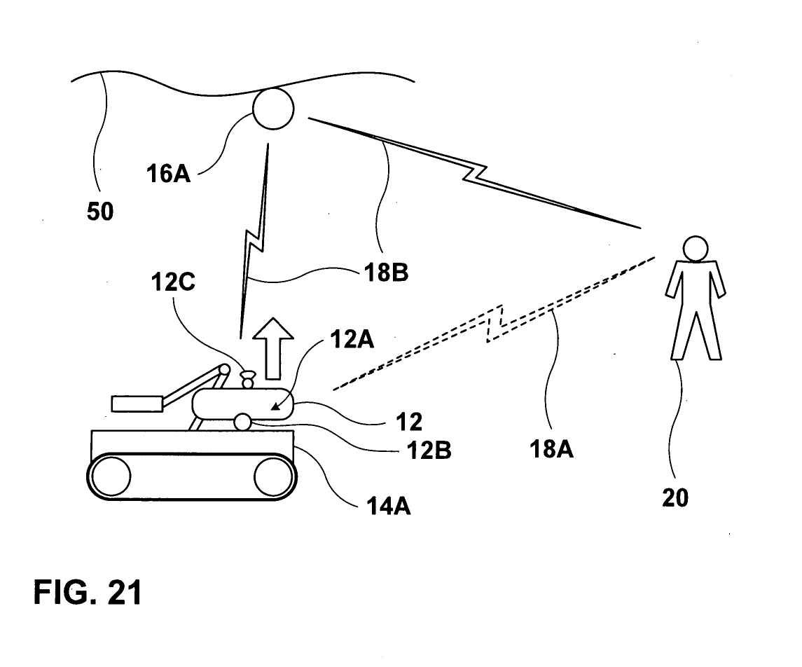

FIG. 20 shows a preferred embodiment of placement of a deployable miniature radio communications relay, radio or node 16. As the UGV 14A moves farther away from its controller 20 the direct communications link 18A gets weaker, that is, the signal fades. One embodiment of a trigger to placement of a deployable radio communications node 16A is signal-to-noise ratio (SNR or S/N). When the direct communications link 18A SNR falls below an established threshold, the canister 12A tells the deployment system 44 to deploy a radio communications node 16, which is ejected from the canister 12 and adheres to a surface 50. When the deployed radio communications node 16A is activated, a communications link 16B is established between the controller 20 and the UGV 14A via the relay node 16B. In an alternative embodiment the controller 20 monitors the communications link 18A SNR and manually directs the canister controller 12A to deploy 44 a communications node 16A. In a further alternative embodiment shown in FIG. 21, the canister 12 is mounted on a pan-and-tilt mechanism 12B that can change the direction of deployment of a radio communications node 16A. A pan-tilt-and-zoom camera 12C is also attached to the canister 12 allowing the controller 20 to identify a favorable position for the deployed radio node 16A and having identified such position direct the canister controller 12A to eject the radio communications node 16A towards that identified position.

### VI. Activation

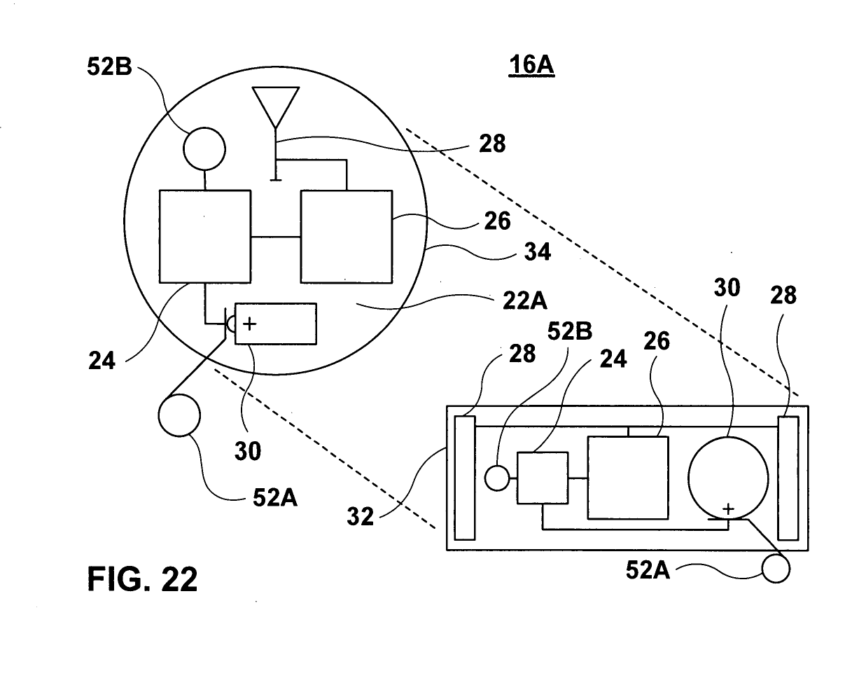

Because in most situations the battery 30 life of the miniature radios or radio means, the deployable miniature radio communications relay, radio or node 16, is limited, an activation means is required when deployed. Preferred embodiments of two activation means 52 are shown in FIG. 22. The first embodiment is a tab 52A that is placed between one of the nodes of the battery 30 and its contact. The tab 52A is removed as the radio communications node 16A is deployed, activating the relay or radio 16. A second embodiment is an acceleration switch 52B, numerous of which are commercially available.

### VII. Alternative Embodiments of the Invention

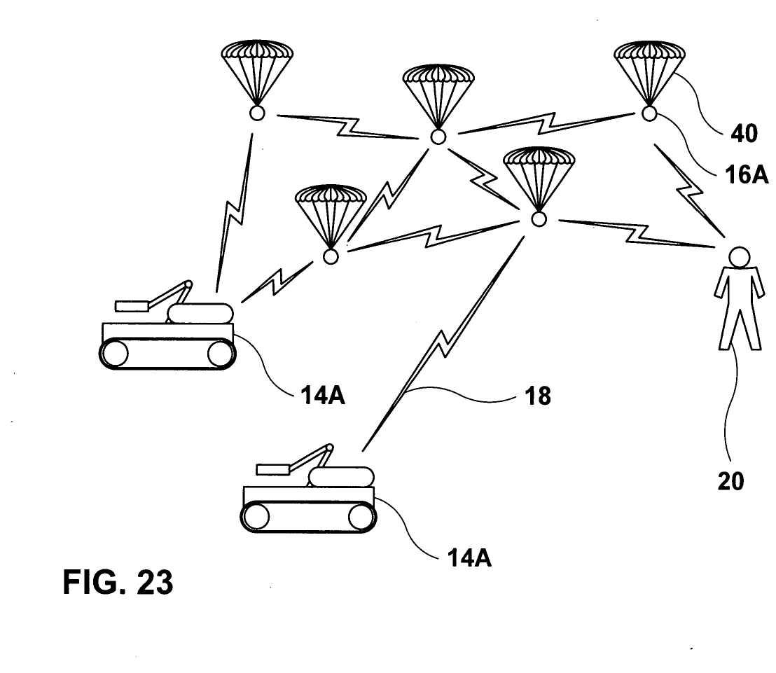

FIG. 23 shows an alternative deployment embodiment in which multiple UGVs 14A communicate 18 via parachute-born 40 radio relay nodes 16A.

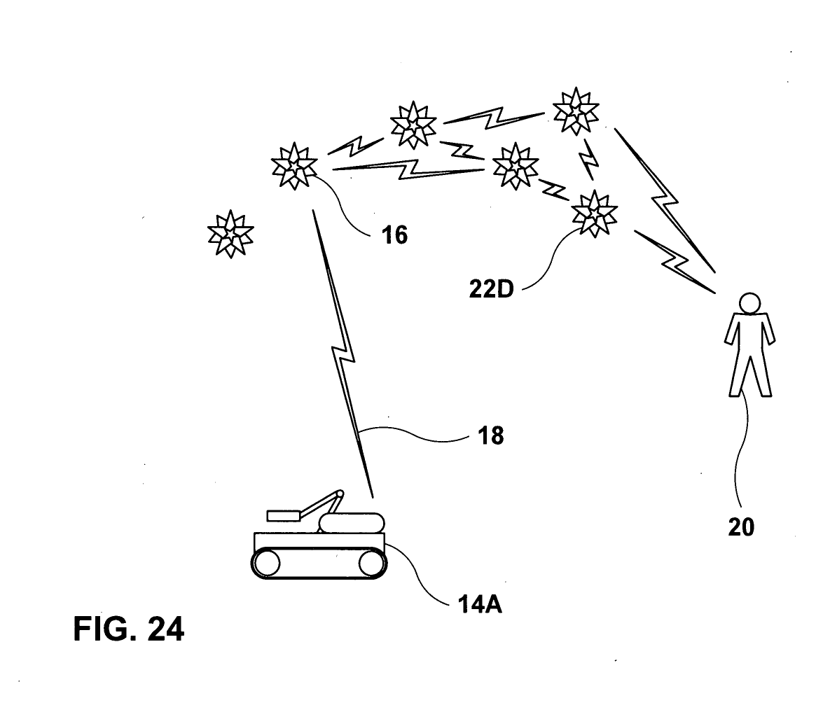

UxVs 14 are often deployed along specific routes via navigation waypoints and are thus out of communications range for extended periods. If the UxV 14 acquires critical information that needs to be communicated immediately, it can establish communications by deploying a plurality of relay communications nodes 16. FIG. 24 shows a pyrotechnic deployment of snowflake 22D radio relay nodes 16.

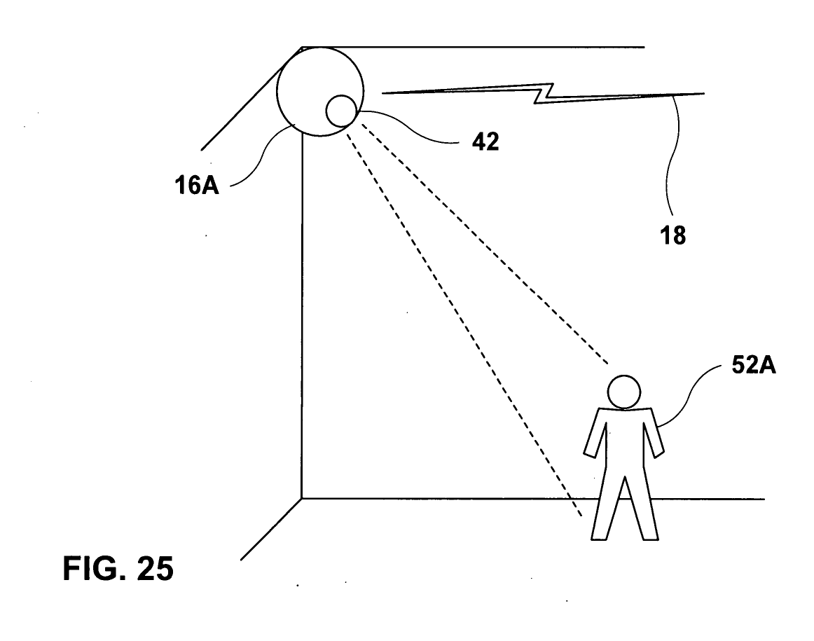

When soldiers clear a room and then leave they would like to know if anyone enters the room after they have left. A specific embodiment of the disclosed invention that enables gathering such information is hand placement of a deployable radio communications node 16A that contains a sensor 42 such as a camera or infrared sensor to observe an unknown person 54A, as shown in FIG. 25.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives that have been disclosed above are intended to educate the reader about preferred embodiments of the invention, and are not intended to constrain the limits of the invention or the scope of Claims.

### LIST OF REFERENCE CHARACTERS

10 Tactical Radio Relay System
12 Canister
12A Canister controller
12B Canister pan-and-tilt mechanism
12C Canister pan-tilt-and-zoom camera
14 Unmanned Vehicle
14A Unmanned Ground Vehicle (UGV)
14B Unmanned Aerial Vehicle (UAV)
14C Unmanned Surface Vehicle (USV)
14D Unmanned Underwater Vehicle (UUV)
16 Deployable radio communications node
16A Spherical deployable radio communications node
16B Tetrahedron deployable radio communications node
16C Cube deployable radio communications node
16D Deployable radio communications node with external antennas
16E Maritime deployable radio communications node
16F Airborne deployable radio communications node
16G Deployable radio communications node with camera
16H Tripod deployable radio communications node
16I Octagon deployable radio communications node
18 Communications Link
20 System controller
22 Deployable radio communications node body
22A Foam deployable radio communications node body
22B Maritime deployable radio communications node body
22C Lifting body deployable radio communications node
22D Snowflake design deployable radio communications node
24 System function controller
26 Wireless radio system
28 Wireless radio system antenna(s)
28A Antenna shaft
28B Antenna shaft barbs
30 Battery
32 Circuit board
34 Adhesion system
36 Anchor system
38 Rotor vane system
40 Parachute
42 Anchor spikes
44 Deployment system for deployable radio communications nodes
44A Spring
44B Ejection plate
44C Electric motor
44D Compressed gas tank
44E Compressed gas nozzle
44F Compressed gas control valve
44G Pyrotechnic means
44H Pyrotechnic means controller
44I Ballistic deployment system
46 Control interface
48 Mechanisms for moving deployable radio communications nodes into a deployment system
48A Plunger and spring mechanism for moving deployable radio communications nodes into a deployment system
48B Cog and tooth mechanism for moving deployable radio communications nodes into a deployment system
50 Adhesion surface
52 Activation means
52A Pull-out tab activation means
52B Acceleration switch activation means
54 Sensor target
54A Unknown person

What is claimed is:

1. A method comprising the steps of:
providing a plurality of miniature radio relay means; each of said miniature radio relay means including an adhesion means for temporarily affixing said miniature radio relay means to another object; and
using said plurality of radio relay means to furnish temporary telecommunications capacity within a target communications zone.

2. A method as recited in claim 1, in which:
each of said miniature radio relay means is a transceiver.

3. A method as recited in claim 1, in which:
each of said miniature radio relay means is a sensor.

4. A method as recited in claim 1, in which:
each of said miniature radio relay means is a monitoring device.

5. A method as recited in claim 1, in which:
said adhesion means is a portion of hook and loop material affixed to each of said miniature radio relay means.

6. A method as recited in claim 1, in which:
said adhesion means is an adhesive applied to each of said miniature radio relay means.

7. A method as recited in claim 1, in which:
said adhesion means is a mechanical connector.

8. A method as recited in claim 1, in which:
said miniature radio relay means is affixed to a building.

9. A method as recited in claim 1, in which:
said miniature radio relay means is affixed to a structure.

10. A method as recited in claim 1, in which:
said target communications zone is a region of a battlefield.

11. A method as recited in claim 1, in which:
said target communications zone is an urban security area.

12. A method as recited in claim 1, in which:
said target communications zone is an area that has been affected by a natural disaster.

13. A method as recited in claim 1, in which:
said target communications zone is an area that has been affected by a terrorist attack.

14. A method as recited in claim 1, further comprising the step of:
providing a deployment means for directing said plurality of miniature radio relay means to their targets.

15. A method as recited in claim 14, in which:
said deployment means is a gun.

16. A method as recited in claim 14, in which:
said deployment means is carried aboard an airborne platform.

17. A method as recited in claim 14, in which:
said deployment means is carried aboard an underwater vehicle.

18. A method as recited in claim 14, in which:
said deployment means is carried aboard a ground vehicle.

19. A method as recited in claim 16, in which:
said airborne platform is an unmanned aerial vehicle.

20. A method as recited in claim 14, in which:
said deployment means includes a canister.

21. A method as recited in claim 1, in which:
one of said plurality of miniature radio relay means communicates with a system controller.

22. A method as recited in claim 1, in which:
one of said plurality of miniature radio relay means communicates with a base station.

23. A method as recited in claim 1, in which:
one of said plurality of miniature radio relay means communicates with another of said plurality of miniature radio relay means.

24. A method as recited in claim 1, in which:
one of said plurality of miniature radio relay means communicates with a mobile terminal.

25. A method as recited in claim 1, in which:
each of said plurality of miniature radio relay means is encapsulated in foam.

26. A method as recited in claim 1, in which:
each of said plurality of miniature radio relay means is configured as a lifting body.

27. A method as recited in claim 1, in which:
each of said plurality of miniature radio relay means is configured in a snowflake shape.

28. A method as recited in claim 1, in which:
each of said plurality of miniature radio relay means is configured as a multifaceted space frame.

29. A method as recited in claim 1, further comprising the step of:
using a plunger and spring mechanism to deploy said plurality of miniature radio relay means.

30. A method as recited in claim 1, further comprising the step of:
using a plunger and spring mechanism to deploy said plurality of miniature radio relay means.

31. A method as recited in claim 1, further comprising the step of:
using a plunger and spring mechanism to deploy said plurality of miniature radio relay means.

32. A method as recited in claim 1, further comprising the step of:
using a cog and tooth mechanism to deploy said plurality of miniature radio relay means.

33. A method as recited in claim 1, further comprising the step of:
using a mechanical mechanism to deploy said plurality of miniature radio relay means.

34. A method as recited in claim 1, further comprising the step of:
using an electrical mechanism to deploy said plurality of miniature radio relay means.

35. A method as recited in claim 1, further comprising the step of:
using a pneumatic mechanism to deploy said plurality of miniature radio relay means.

36. A method as recited in claim 1, further comprising the step of:
using a pyrotechnic mechanism to deploy said plurality of miniature radio relay means.

37. A method as recited in claim 1, further comprising the step of:
using a ballistic mechanism to deploy said plurality of miniature radio relay means.

38. A method as recited in claim 1, further comprising the step of:
deploying and activating one of said plurality of miniature radio relay means when a communications link signal-to-noise ratio falls below an established threshold

39. A method as recited in claim 1, in which:
said plurality of miniature radio relay means operate for a limited amount of time, generally until their batteries fail.

40. A method as recited in claim 1, in which:
said plurality of miniature radio relay means operate for a limited amount of time, generally until their mission objectives have been achieved.

41. A method as recited in claim 1, in which:
said plurality of miniature radio relay means operate using cellular, UHF, VHF, Wi-Fi, WiMAX, MIMO, or ISM frequency bands.

42. An apparatus comprising:
a plurality of miniature radio relay transceivers; said plurality of miniature radio transceivers being temporarily deployed in a target communications zone;
each of said plurality of miniature radio relay transceivers including an adhesion mechanism for adhering to another object;
each of said plurality of miniature radio relay transceivers including an adhesion mechanism for adhering to another object;

43. An apparatus as recited in claim 42, further comprising:
a system function controller;
a wireless radio system; said wireless radio system being connected to said system function controller;
an antenna; said antenna being coupled to said wireless radio system; and
a battery; said battery being coupled to said wireless radio system.

44. An apparatus as recited in claim 42, in which:
said antenna is a radio frequency conductive mesh.
